(19) United States
(12) Patent Application Publication
(10) Pub. No.: US 2025/0026156 A1
(43) Pub. Date: Jan. 23, 2025

(54) LOAD-RESISTENT PNEUMATIC VEHICLE TYRES WITH REDUCED NOISE EMISSION

(71) Applicant: Continental Reifen Deutschland GmbH, Hannover (DE)

(72) Inventors: Reinhard Ludwig, Nienburg (DE); Oliver Schürmann, Langenhagen (DE); Jürgen Hölzer, Wedemark-Mellendorf (DE); Fabian Günzler, Wunstorf (DE)

(73) Assignee: Continental Reifen Deutschland GmbH, Hannover (DE)

(21) Appl. No.: 18/715,112

(22) PCT Filed: Oct. 25, 2022
(86) PCT No.: PCT/DE2022/200243

§ 371 Date: May 30, 2024

(30) Foreign Application Priority Data
Dec. 3, 2021 (DE) 10 2021 213 750.4

(51) Int. Cl. B60C 15/06

(52) U.S. Cl. CPC B60C 15/0632

(57) ABSTRACT

The invention relates to a pneumatic vehicle tire, comprising: a) a tire carcass with a first bead area, a first sidewall area, a central area, a second sidewall area and a second bead area, b) a tread, lying on the outside in the radial direction relative to the tire carcass and arranged over the central area, c) a first flipper strip, arranged at the first bead area, and a second flipper strip, arranged at the second bead area, d) a first upper reinforcing element, arranged at the central area and at the first sidewall area, and a second upper reinforcing element, arranged at the central area and at the second sidewall area, and e) a first lower reinforcing element, arranged at the first bead area, and a second lower reinforcing element, arranged at the second bead area, the first upper reinforcing element (30) and the second upper reinforcing element being located at a distance from the first lower reinforcing element and the second lower reinforcing element.

### CROSS-REFERENCE TO RELATED APPLICATIONS

The present application is a National Stage Application under 35 U.S.C. § 371 of International Patent Application No. PCT/DE2022/200243 filed on Oct. 25, 2022, the disclosures of which are herein incorporated by reference in their entireties.

### BRIEF SUMMARY

The invention relates to a pneumatic vehicle tire, in particular a load-resistant pneumatic vehicle tire with reduced noise emission during operation.

Modern pneumatic vehicle tires are usually exposed to a wide range of mechanical loads during use. A particularly severe mechanical load often occurs when the pneumatic vehicle tire runs over an obstacle, for example in the form of potholes or curbs. In particular, when the pneumatic vehicle tire comes up against the edge of an obstacle substantially perpendicularly, it is subjected to severe loading and deformed. This involves the sidewall of the pneumatic vehicle tire being creased and crushed between the rim flange and the obstacle. As a result, very high forces occur locally, which can for example cause the reinforcing cords in the tire carcass to tear and thus cause local material failure.

The material defects occurring in the pneumatic vehicle tire when there is loading of the form described above are often manifested as material cracks resulting from the deformation undergone, which occur both in the shoulder area and in the bead area of the pneumatic vehicle tire. This characteristic defect pattern is sometimes also referred to as “snake bites”, as the two cracks resemble the fangs of a snake. The basic structure of modern pneumatic vehicle tires is sufficiently well known from the prior art and is disclosed for example in JP 2001191722A, JP 2019026231, U.S. Pat. Nos. 3,554,261A, 4,185,675 A1 or US 2014/0124116 A1.

It is known that the resistance of the pneumatic vehicle tire to such damage that occurs when potholes or other obstacles are run over can be increased by using multiple carcass plies in the pneumatic vehicle tire, so that the carcass has a multi-ply structure in the side area, which gives the tire the necessary mechanical resistance. However, it is disadvantageous that additional carcass plies increase the overall weight of the pneumatic vehicle tire and in most cases also the rolling resistance of the tire. It is most particularly disadvantageous, however, that additional carcass plies also transmit the driving noises that occur during operation more intensively and contribute to a higher noise level during operation, which is also referred to as “rumble noise”. There is therefore a conflict of objectives between optimized sidewall robustness on the one hand and low rolling resistance and advantageous noise emission, in particular in the frequency range up to 180 Hz, on the other hand.

### DETAILED DESCRIPTION

The primary object of the present invention was to eliminate or at least reduce the disadvantages of the prior art.

In particular, it was an object of the present invention to provide a pneumatic vehicle tire with which the conflict of objectives between sidewall robustness and favorable rolling resistance as well as advantageous noise behavior can be improved. In particular, it was the object of the present invention that the conflict of objectives between sidewall robustness and the noises occurring during the operation of the pneumatic vehicle tires is optimized as best as possible.

It was desirable that the vehicle tires to be provided should have excellent driving properties and also have a great resistance to mechanical damage when rolling over angular obstacles, which should advantageously be comparable with those vehicle tires that use multiple carcass plies. In this respect, it was an object of the invention that the occurrence of defects known as “snake bites” should be reduced or even completely suppressed, or that the susceptibility to these defects and their effects on operational safety should be reduced.

In this respect, it was desirable that the pneumatic vehicle tires to be provided are very flexible with regard to the structural design measures used to solve the above problems and that the solution found can be easily adapted to different existing constructions of pneumatic vehicle tires. In this respect, it was desirable that the pneumatic vehicle tires to be provided should be able to be produced using such materials and production methods as are already used today in the production of modern pneumatic vehicle tires.

It was a supplementary object of the present invention to specify preferred configurations with which the resistance to mechanical damage of the pneumatic vehicle tires to be provided can be further increased and which allows a specific adaptation of the pneumatic vehicle tires to be provided to different loading scenarios, so that the pneumatic vehicle tires to be provided can be specifically designed for particularly demanding applications.

It was a supplementary specification of the present invention that the overall weight of the pneumatic vehicle tires to be provided and the rolling resistance should not be disadvantageous compared to a pneumatic vehicle tire with a multi-ply carcass design and ideally even improved.

The inventors of the present invention have now recognized that the objects described above can surprisingly be achieved if, instead of an additional carcass ply, reinforcing elements are just selectively placed at specific positions of the pneumatic vehicle tire, as defined in the claims. It was possible to conclude this surprising teaching from experiments in which the lowest carcass ply of a multi-ply tire carcass was interrupted specifically selectively in the sidewall area of the tire carcass, so that there was no direct connection between the two parts of the split carcass ply. By interrupting the carcass ply, a spring stiffness of the sidewall was initially achieved, similar to that of a merely single-ply carcass. This surprisingly allowed the noise level during use of the pneumatic vehicle tires to be improved, in particular in the low-frequency range up to 180 Hz. At the same time, it was surprisingly possible to maintain in effect a double-ply carcass design in the zones of the pneumatic vehicle tire in which sidewall crushing and resulting defects occur(s) in the event of running over an obstacle, thereby locally ensuring the necessary mechanical stability and resistance to damage. On the basis of these promising results, the inventors of the present invention succeeded in advantageously developing the teaching further, it surprisingly being found that the advantages described above can be achieved by the specifically selective use of reinforcing elements, whereby a significant simplification of the tire structure and a further reduction of the tire weight as well as an improvement of the rolling resistance can be achieved without adversely affecting the mechanical stability and the resistance to “snake bites”.

The objects stated above are therefore achieved by the subject matter of the invention as defined in the claims. Preferred configurations according to the invention will be apparent from the subclaims and from the details that follow.

Embodiments that are referred to below as preferred are combined with features of other embodiments that are referred to as preferred in particularly preferred embodiments. Most particularly preferred are therefore combinations of two or more of the embodiments that are referred to below as particularly preferred. Likewise preferred are embodiments in which a feature of one embodiment that is referred to as preferred to a certain extent is combined with one or more further features of other embodiments that are referred to as preferred to a certain extent.

The invention relates to a pneumatic vehicle tire, comprising:
a) a tire carcass with a first bead area, a first sidewall area, a central area, a second sidewall area and a second bead area,
b) a tread, lying on the outside in the radial direction relative to the tire carcass and arranged over the central area,
c) a first flipper strip, arranged at the first bead area, and a second flipper strip, arranged at the second bead area,
d) a first upper reinforcing element, arranged at the central area and at the first sidewall area, and a second upper reinforcing element, arranged at the central area and at the second sidewall area, and
e) a first lower reinforcing element, arranged at the first bead area, and a second lower reinforcing element, arranged at the second bead area, the first upper reinforcing element and the second upper reinforcing element being located at a distance from the first lower reinforcing element and the second lower reinforcing element.

Pneumatic vehicle tires that have a tire carcass are known to a person skilled in the art from the prior art. Preferred here is a pneumatic vehicle tire according to the invention wherein the pneumatic vehicle tire is a car tire. It is also customary that a tread intended for later contact with the road surface is provided above the tire carcass, i.e. radially lying on the outside. Preferred here is a pneumatic vehicle tire according to the invention wherein the tread has a profile on the outer side facing away from the tire carcass. Also preferred is a pneumatic vehicle tire according to the invention wherein the tread comprises one or more tread rubber materials.

In addition, the pneumatic vehicle tires known from the prior art often have a bead area on both sides, intended to provide the necessary stability when the pneumatic vehicle tire is fitted on a rim.

Modern pneumatic vehicle tires in most cases have an ideal rotational symmetry, so that they often have substantially the same cross section along the entire circumference. It is therefore customary for the skilled person to describe the structure of pneumatic vehicle tires by presenting a cross-sectional view. However, it is self-evident to the skilled person that the tire carcass with its areas, the tread and the flipper strips are filamentary or annular elements, which usually extend around the entire pneumatic vehicle tire.

Pneumatic vehicle tires are elastomeric products of which the form and shape significantly depend not only on the construction, but also on the pressure inside the pneumatic vehicle tire or the load undergone during use. In this respect, the skilled person is fully aware that the precise description of the position of components in the cross-sectional view of the pneumatic vehicle tire is not a trivial matter. It is therefore useful to identify different areas on the carcass relative to which the position of the components used can be easily defined. In accordance with the understanding of a person skilled in the art, the tire carcass has a central area, which runs below the tread and which is framed on both sides by a sidewall area of the tire carcass. Relevant in this respect for the majority of tire constructions is a pneumatic vehicle tire according to the invention wherein the width of the central area corresponds to the width of the tread, in each case transversely to the circumferential direction, and the tread is arranged completely above the central area in the radially outward direction.

The sidewall areas lie in the pneumatic vehicle tire in the area of the tire sidewall, the part of the pneumatic vehicle tire that is often referred to by the skilled person as the tire shoulder being located at the transition between the central area and the two sidewall areas. The lower ends of the two sidewall areas are adjoined by the bead areas, i.e. the areas of the tire carcass that are arranged in the area of the tire bead. Since the pneumatic vehicle tires defined above have a so-called flipper strip on both sides, the respective bead areas can be easily identified by the skilled person by the position of the flipper strip. Relevant for the majority of tire constructions is therefore a pneumatic vehicle tire according to the invention wherein the first bead area of the tire carcass extends from the lowest point of the tire carcass in the radial direction to the level of the first flipper strip, and wherein the second bead area of the tire carcass extends from the lowest point of the tire carcass in the radial direction to the level of the second flipper strip.

Also relevant for the majority of tire constructions is therefore a pneumatic vehicle tire according to the invention wherein the first sidewall area is arranged between the first bead area and the central area, and wherein the second sidewall area is arranged between the second bead area and the central area, and/or wherein the first sidewall area and the second sidewall area do not lie below the tread and below a flipper strip and/or wherein the transition from the central area to the first sidewall area and the second sidewall area takes place at the level of the tire shoulders.

Although the theoretical subdivision of the tire carcass into the various areas may seem artificial at first glance, it is however easy and reliable for the skilled person to obtain in practice, since the skilled person can in practice easily identify the central area, which at the shoulders of the tire goes over into the two sidewall areas, which in turn go over into the bead areas at the level of the flipper strips. In addition to these areas, in most cases the tire carcass of modern pneumatic vehicle tires also includes turn-up areas, i.e. areas of the tire carcass which are turned up around the bead at the end of the bead areas and run back in the direction of the tread as a turn-up on the side of the tire carcass.

The pneumatic vehicle tire according to the invention thus comprises at least four different reinforcing elements, two of which are arranged in the upper area of the pneumatic vehicle tire and two in the lower area of the pneumatic vehicle tire. The upper reinforcing elements are arranged in the area of the tire shoulder, i.e. at the connection between the central area and the sidewall area, in such a way that they are in contact with the central area and the first and the second sidewall area respectively. Correspondingly, these reinforcing elements are also referred to as shoulder reinforcements. By contrast, the second pair of reinforcing elements is arranged in the respective bead areas, i.e. is fastened to the tire carcass in such a way that the lower reinforcing elements at least partially extend into the respective bead areas.

The above definition with respect to the distance between the respective reinforcing elements means that the upper reinforcing elements are not in direct contact with the lower reinforcing elements, i.e. that the first upper reinforcing element and the first lower reinforcing element are located at a distance and separated from each other in the same way as the second upper reinforcing element and the second lower reinforcing element. It is understood that the first and the second lower reinforcing element are also separated from the opposite second and first upper reinforcing element respectively. Therefore, at least the lower reinforcing elements are separate reinforcing elements.

In view of the symmetry prevailing in a pneumatic vehicle tire, it is understandable for the skilled person why the components described above, which are in most cases arranged in the area of the sidewall of the pneumatic vehicle tire, are respectively defined by a first and a second element, since they are understandably present on both sides of the pneumatic vehicle tire. It may be advantageous for certain highly specialized applications to design the different sides of the pneumatic vehicle tire differently and for this purpose for example make the type and/or position of the first and the second lower reinforcing element different on the different sides of the pneumatic vehicle tire. However, the skilled person understands that for the majority of applications it is explicitly preferred if the pneumatic vehicle tire has a substantially identical construction on both sides of the pneumatic vehicle tire, so that the first and second elements are in each case designed and positioned in the same way.

Correspondingly, in all of the subsequent considerations it is most particularly preferred if the respective features of preferred embodiments are implemented in the same way on both sides of the pneumatic vehicle tire, i.e. respectively for the first and second elements.

As described above, the flipper strips and the reinforcing elements are arranged on the carcass. In accordance with the understanding of a person skilled in the art, this means that the components are mounted on the carcass in such a way that they are at least partially in direct contact with the tire carcass and for example are not separated by additional breaker plies or separate rubber layers apart from any thin adhesion-promoting layers.

Preferred in principle is a pneumatic vehicle tire according to the invention, additionally comprising a first sidewall, arranged on the outside of the first sidewall area, and/or a second sidewall, arranged on the outside of the second sidewall area.

According to the inventors' assessment, it is advantageous, in particular with regard to the overall weight of the pneumatic vehicle tire, if the first and second upper reinforcing elements are designed as separate elements, which are in each case arranged in the shoulder areas, i.e. at the transition between the central area and the respective sidewall areas, as described above. Preferred therefore is a pneumatic vehicle tire according to the invention wherein the first upper reinforcing element and the second upper reinforcing element are located at a distance from one another.

Found to be a powerful alternative to this however is the configuration in which the first and second upper reinforcing elements are not designed as separate, but are formed by a single reinforcing ply, which correspondingly extends from the first sidewall area through the central area into the second sidewall area. This advantageously has the effect of achieving great stiffness, in particular in the area below the tread, which can be advantageous for certain applications. A corresponding structure in the upper part of the pneumatic vehicle tire is in this case similar to an embodiment such as that which can be obtained with a so-called ½-carcass ply. Alternatively preferred therefore is a pneumatic vehicle tire according to the invention wherein the first upper reinforcing element and the second upper reinforcing element are formed by a reinforcing ply, wherein the reinforcing ply preferably extends over the entire central area into the sidewall areas.

It can be regarded as an advantage of the pneumatic vehicle tire according to the invention that the reinforcing elements can be positioned flexibly, to be specific on the inner side and outer side of the tire carcass. In accordance with the understanding of a person skilled in the art, the term inner side refers here to the side of the tire carcass that is facing the inside of the annular pneumatic vehicle tire, i.e. in the direction of the cavity of the pneumatic vehicle tire that is filled with air during operation. According to the inventors' assessment, the mounting of the reinforcing elements on the outer side of the tire carcass may be advantageous in that it is easier to produce it in typical tire construction processes. However, with regard to the protective effect against unwanted mechanical damage, the positioning on the inner side of the tire carcass is preferred according to the inventors' assessment. Against this background, preferred is a pneumatic vehicle tire according to the invention wherein the first upper reinforcing element and the second upper reinforcing element are arranged on the outer side or inner side, preferably on the inner side, of the tire carcass, and/or wherein the first lower reinforcing element and the second lower reinforcing element are arranged on the outer side or inner side, preferably on the inner side, of the tire carcass.

Based on the inventors' experiments, it is particularly advantageous if the reinforcing elements are in each case arranged on the same side of the tire carcass. Preferred therefore is a pneumatic vehicle tire according to the invention wherein the first upper reinforcing element and the first lower reinforcing element and/or the second upper reinforcing element and the second lower reinforcing element, preferably all of the reinforcing elements, are arranged on the same side of the tire carcass.

Modern pneumatic vehicle tires often include a so-called inner tire layer, which is used in particular for the airtight sealing of the tire. If such an inner tire layer is provided, it is regarded as particularly advantageous to arrange the reinforcing elements between the inner tire layer and the tire carcass. It can be seen as a particular advantage of this configuration that the reinforcing elements not only allow increased mechanical stability and greater resistance to “snake bites”, but also provide an additional sealing layer for the inner tire layer in the areas that are particularly under load, so that unwanted perforation of the inner tire layer is additionally prevented by the reinforcing elements. Preferred therefore is a pneumatic vehicle tire according to the invention, additionally comprising an inner tire layer that is inward relative to the tire carcass in the radial direction, wherein the first upper reinforcing element and/or the first lower reinforcing element and/or the second upper reinforcing element and/or the second lower reinforcing element, preferably all of the reinforcing elements, are arranged between the tire carcass and the inner tire layer.

The solution to the problem identified by the inventors is advantageously very flexible with regard to the remaining structure of the pneumatic vehicle tire, so that the use of additional plies, for example breaker plies, between the tire carcass and the tread is also possible, so that the properties of the pneumatic vehicle tire can be specifically adjusted without adversely affecting the advantages made possible by the invention. Accordingly preferred is a pneumatic vehicle tire according to the invention, additionally comprising between the tread and the tire carcass over the central area at least one further ply, preferably exactly one further ply, wherein the further ply is preferably a breaker ply, wherein the further ply particularly preferably comprises ply strength members that are embedded in a ply rubber material, wherein the further ply particularly preferably overlaps with the first upper reinforcing element and/or the second upper reinforcing element, or wherein the tread is arranged directly on the radially outer-lying side of the tire carcass.

As explained above, it is common in many cases that the tire carcass is turned around the tire bead, creating so-called turn-up areas, which adjoin the respective bead areas. This is often preferred with regard to the stability of the pneumatic vehicle tire and the secure fixing on the rim. In the presence of turn-up areas, the inventors propose that the respective flipper strips can be advantageously of a two-part design. With a substantially identical overall form of the flipper strip, the turn-up area is in effect made to pass through the flipper strip, so that it is divided into two areas by the turn-up area. One part of the flipper strip is thereby arranged between the turn-up area and the bead area of the tire carcass, while the second part of the flipper strip, which is also referred to as the “outer apex”, lies on the outer side of the turn-up area. This results in a particularly advantageous structure, which can be fixed particularly securely on the rim and which has excellent mechanical properties in the side area of the pneumatic vehicle tires with at the same time low noise generation during operation. Correspondingly preferred is a pneumatic vehicle tire according to the invention wherein the tire carcass additionally comprises a first turn-up area, connected to the first bead area, and/or a second turn-up area, connected to the second bead area, wherein the first turn-up area and/or the second turn-up area preferably lie(s) on the outside relative to the respective bead area. Particularly preferred here is a pneumatic vehicle tire according to the invention wherein the first flipper strip and/or the second flipper strip is/are of a two-part design, wherein the first flipper strip is preferably arranged partially between the first bead area and the first turn-up area and partially on the outer side of the first turn-up area and/or wherein the second flipper strip is preferably arranged partially between the second bead area and the second turn-up area and partially on the outer side of the second turn-up area.

In principle, it is possible to make the turned-up areas of the tire carcass so long that the resulting turn-up areas run along the bead area and the sidewall area of the tire carcass, for example up to the tread. However, with regard to the reinforcing elements to be used in the pneumatic vehicle tire according to the invention, it has been found to be particularly advantageous if the height of the turn-up areas is selected such that the end of the turn-up area relative to the tire carcass lies at about the same level as the respective lower reinforcing element. Preferred therefore is a pneumatic vehicle tire according to the invention wherein the first turn-up area and/or the second turn-up area on the side of the tire carcass extend(s) so high that the end of the respective turn-up area in the respective sidewall area is arranged at the level of the respective lower reinforcing element.

With regard to greatest possible resistance to crushing of the sidewall, it is in principle actually preferred to provide multiple carcass plies. In order to solve the conflict of objectives described above, however, it is explicitly preferred if the tire carcass only comprises one carcass ply, since this, in combination with the reinforcing elements to be used according to the invention, allows good resistance to mechanical damage when running over obstacles, with at the same time excellent noise properties. In the prior art it was proposed that the one or one of multiple carcass plies below the tread can be provided with an interruption, which may be advantageous for specific applications. With regard to the pneumatic vehicle tires according to the invention, it is explicitly preferred however if the at least one or even all of the carcass plies are continuous carcass plies, i.e. carcass plies that are not interrupted. Preferred therefore is a pneumatic vehicle tire according to the invention wherein the tire carcass comprises one or more carcass plies, preferably exactly one carcass ply, and/or wherein at least one carcass ply, preferably all of the carcass plies, extend(s) as a continuous carcass ply through all of the areas of the tire carcass.

In principle, the pneumatic vehicle tires according to the invention are very flexible with regard to the structure of the tire carcass. It is explicitly preferred however if the carcass plies comprise strength members that are embedded in a rubber material. Preferred in this respect is a pneumatic vehicle tire according to the invention wherein the one or more carcass plies comprise(s) a plurality of carcass strength members that are embedded in a carcass rubber material.

In this respect, the inventors of the present invention have succeeded in identifying strength members and rubber materials with which high-performance tire carcasses can be obtained in pneumatic vehicle tires according to the invention. To be specific, preferred is a pneumatic vehicle tire according to the invention wherein the carcass strength members are selected from the group consisting of metallic and textile strength members, preferably textile strength members, particularly preferably textile strength members with at least one yarn, wherein the yarn consists of a material which is selected from the group consisting of aramid, polyethylene terephthalate, polyether ketone, polyketone, polyethylene naphtalate, Rayon, viscose, carbon fibers, natural fibers, glass fibers and PBO (poly(p-phenylene-2,6-benzobisoxazole)), most particularly preferably selected from the group consisting of aramid and polyethylene terephthalate. Also preferred is a pneumatic vehicle tire according to the invention wherein the carcass rubber material can be produced by vulcanizing a vulcanizable carcass rubber mixture, wherein the vulcanizable carcass rubber mixture preferably comprises at least one diene rubber and at least one filler.

In many cases, pneumatic vehicle tires have so-called bead cores in the bead. The presence of bead cores is strongly preferred for the pneumatic vehicle tires according to the invention, these being assigned within the scope of the present invention to the first or second flipper strip, which may comprise the bead cores. Consequently preferred is a pneumatic vehicle tire according to the invention wherein the first flipper strip and/or the second flipper strip comprise(s) a bead core, wherein the bead core is preferably a hexagonal core.

According to the inventors' assessment, it is particularly advantageous if the flipper strip is formed from a rubber material which has a greater stiffness, and therefore a higher modulus of elasticity, than the rubber materials of the reinforcing elements. Preferred in this respect is initially a pneumatic vehicle tire according to the invention wherein the first flipper strip and/or the second flipper strip comprise(s) a flipper-strip rubber material. Preferred here is a pneumatic vehicle tire according to the invention wherein the flipper-strip rubber material can be produced by vulcanizing a vulcanizable flipper-strip rubber mixture, wherein the vulcanizable flipper-strip rubber mixture preferably comprises at least one diene rubber and at least one filler. Particularly preferred is a pneumatic vehicle tire according to the invention wherein the flipper-strip rubber material has a higher modulus of elasticity than the carcass rubber material, wherein the flipper-strip rubber material preferably has a higher modulus of elasticity than the rubber materials of the reinforcing elements. In the context of the present invention, the term modulus of elasticity denotes the average dynamic storage modulus E′, which, for rubber materials, is determined from a dynamic-mechanical measurement at 55° C. in accordance with DIN 53513:1990-03, wherein the average dynamic storage modulus E′ is the average of two measurements at 0.15% elongation and 8% elongation.

The inventors have recognized that the reinforcing elements to be used according to the invention can advantageously be made particularly thin without losing the advantageous effect on the sidewall robustness, which is favorable in particular for the overall weight and the rolling resistance. Preferred therefore is a pneumatic vehicle tire according to the invention wherein the first upper reinforcing element and/or the first lower reinforcing element and/or the second upper reinforcing element and/or the second lower reinforcing element, preferably all of the reinforcing elements, has/have a thickness in the range of 0.2 to 4.0 mm, preferably in the range of 0.5 to 2.5 mm, particularly preferably in the range of 0.9 to 1.8 mm.

Even if it would at least theoretically be possible in principle to use different materials as reinforcing elements, for example metallic reinforcing elements, it is unreservedly preferred with regard to the performance and processing properties of the pneumatic vehicle tires according to the invention for all embodiments if the reinforcing elements consist at least partially, preferably substantially completely, of a rubber material. Correspondingly preferred is a pneumatic vehicle tire according to the invention wherein the first upper reinforcing element comprises a first rubber material, and/or wherein the second upper reinforcing element comprises a second rubber material, and/or wherein the first lower reinforcing element comprises a third rubber material, and/or wherein the second lower reinforcing element comprises a fourth rubber material. Also preferred is a pneumatic vehicle tire according to the invention wherein the first rubber material and/or the second rubber material and/or the third rubber material and/or the fourth rubber material, preferably all of the rubber materials, can be produced by vulcanizing a corresponding vulcanizable rubber mixture, wherein the corresponding vulcanizable rubber mixture preferably comprises at least one diene rubber and at least one filler.

In this respect, it has been found to be an advantage of the pneumatic vehicle tires according to the invention that the reinforcing elements can be produced from the same rubber material to ensure that they are easy to produce. Correspondingly preferred is a pneumatic vehicle tire according to the invention, wherein the first rubber material and the second rubber material and/or the third rubber material and the fourth rubber material, preferably all of the rubber materials, are identical.

According to the inventors' assessment, to ensure the greatest possible sidewall robustness and optimized resistance to mechanical loading when running over obstacles, it is most particularly preferred if the reinforcing elements are formed from rubber materials that have a greater stiffness than the rubber material used in the carcass. Consequently preferred is a pneumatic vehicle tire according to the invention wherein the first rubber material and/or the second rubber material and/or the third rubber material and/or the fourth rubber material, preferably all of the rubber materials, has/have a higher modulus of elasticity than the carcass rubber material.

In addition to such reinforcing elements that are formed completely from rubber material, preferred are such reinforcing elements which comprise a plurality of strength members that are embedded in the corresponding rubber materials, wherein advantageously the same materials can be used as for the strength members of the tire carcass. Accordingly preferred is a pneumatic vehicle tire according to the invention wherein the first upper reinforcing element comprises a plurality of first strength members, and/or wherein the second upper reinforcing element comprises a plurality of second strength members, and/or wherein the first lower reinforcing element comprises a plurality of third strength members, and/or wherein the second lower reinforcing element comprises a plurality of fourth strength members. Preferred here is a pneumatic vehicle tire according to the invention wherein the first strength members and/or second strength members and/or third strength members and/or fourth strength members, preferably all of these strength members, are selected from the group consisting of metallic and textile strength members, preferably textile strength members, particularly preferably textile strength members with at least one yarn, wherein the yarn consists of a material selected from the group consisting of aramid, polyethylene terephthalate, polyether ketone, polyketone, polyethylene naphthalate, Rayon, viscose, carbon fibers, natural fibers, glass fibers and PBO (poly(p-phenylene-2,6-benzobisoxazole)), most particularly preferably selected from the group consisting of aramid and polyethylene terephthalate.

To achieve optimum tire properties, in particular advantageous sidewall robustness, with at the same time advantageous noise behavior, it is however explicitly preferred according to the inventors' knowledge if different strength members are used in the reinforcing elements than in the tire carcass, wherein for example the use of aramid in the reinforcing elements leads to excellent results. In addition or alternatively, it is also preferred if the strength members of the lower reinforcing elements are different from those of the upper reinforcing elements. This advantageous configuration makes it possible particularly well to adjust the sidewall properties of the pneumatic vehicle tires to the specific requirements, for example by using stiffer strength members in the lower reinforcing elements, whereas for the upper reinforcing elements the emphasis is placed on flexibility. Consequently preferred is a pneumatic vehicle tire according to the invention wherein the first strength members and/or second strength members and/or third strength members and/or fourth strength members, preferably the third strength members and fourth strength members, particularly preferably all of these strength members, are different from the carcass strength members, preferably with regard to the material and/or the fineness. Likewise preferred is a pneumatic vehicle tire according to the invention wherein the first strength members and the second strength members are different from the third strength members and the fourth strength members.

The inventors of the present invention have surprisingly found that reinforcing elements comprising strength members can achieve a particularly advantageous effect if the alignment of the strength members in the reinforcing elements does not correspond to the alignment of the carcass strength members, for example if the strength members in the reinforcing elements in traditional radial-ply tires (cord angle approx. 90°) themselves have cord angles that differ from 90 degrees. This results in a cross-woven fabric when the plies of strength members are viewed from above, whereby a particularly high stability can be realized in the areas of the reinforcing elements. Accordingly preferred is a pneumatic vehicle tire according to the invention wherein the strength members in the first upper reinforcing element and/or in the first lower reinforcing element and/or in the second upper reinforcing element and/or in the second lower reinforcing element, preferably the strength members in the first lower reinforcing element and in the second lower reinforcing element, have a cord angle in the range of 30° to 90°, preferably 70° to 86°, relative to the circumferential direction, and/or wherein the strength members in the first upper reinforcing element and/or in the first lower reinforcing element and/or in the second upper reinforcing element and/or in the second lower reinforcing element, preferably the strength members in the first lower reinforcing element and in the second lower reinforcing element, have a cord angle relative to the circumferential direction that differs from the cord angle of the carcass strength members in the tire carcass. Cord angles in the reinforcing elements deviating from 90°, in combination with a carcass ply with an opposite cord angle, i.e. also deviating from 90°, of the carcass strength members, lead to particularly high stability in the area of the reinforcing elements. It is preferred here if the carcass strength members have a cord angle of about 82° relative to the direction of rotation and the strength members in the reinforcing elements have a cord angle of about 82° relative to the direction of rotation, although the pitch of the strength members has a different sign, so that the strength members in the reinforcing elements include an angle of about 164° in the circumferential direction with the carcass strength members.

According to the inventors' assessment, the position of the lower reinforcing elements can and should be advantageously made to match the rest of the construction of the pneumatic vehicle tire, to be specific by adjusting the relative position on the tire carcass, i.e. the height of the lower reinforcing elements. For some applications, it may be preferred here if the lower reinforcing elements are arranged exclusively in the respective bead areas, i.e. do not extend into the sidewall areas and therefore end substantially at the latest at the same level as the flipper strips. According to the inventors' assessment however, it is advantageous for the majority of applications if the lower reinforcing elements from the bead area extend beyond the end of the flipper strips into the sidewall area because in many cases this area undergoes particularly high mechanical loading and the additional reinforcement by the lower reinforcing elements allows a particularly efficient increase in durability. However, with regard to optimizing noise generation, the inventors propose that the lower reinforcing elements should also not extend too far into the sidewall area of the tire carcass, so that it is advantageous if a large part of the reinforcing elements is arranged in the bead area on the tire carcass. Preferred in this light is a pneumatic vehicle tire according to the invention wherein the first lower reinforcing element and/or the second lower reinforcing element, preferably both lower reinforcing elements, is/are arranged completely on the respective bead area. Alternatively preferred is a pneumatic vehicle tire according to the invention wherein the first lower reinforcing element and/or the second lower reinforcing element, preferably both lower reinforcing elements, is/are in each case arranged in the corresponding sidewall area and in the corresponding bead area, wherein the first lower reinforcing element and/or the second lower reinforcing element is/are particularly preferably arranged 5 to 50%, preferably 10 to 40%, particularly preferably 15 to 30%, in the respective sidewall area, based on the respective width of the reinforcing element.

The inventors of the present invention have advantageously succeeded in specifying widths suitable for the reinforcing elements, i.e. for the extent along the course of the tire carcass in cross section. To be specific, preferred is a pneumatic vehicle tire according to the invention wherein the first lower reinforcing element and/or the second lower reinforcing element, preferably both lower reinforcing elements, has/have a width in the range of 20 to 100 mm, preferably in the range of 30 to 80 mm, particularly preferably in the range of 40 to 60 mm, and/or wherein the first upper reinforcing element and/or the second upper reinforcing element, preferably both upper reinforcing elements, has/have a width in the range of 20 to 100 mm, preferably in the range of 30 to 80 mm, particularly preferably in the range of 40 to 60 mm.

In addition to the dimensions specified above, the inventors have also been able to specify particularly expedient distances between the upper and lower reinforcing elements, to be precise both in absolute terms and in relation to the length of the lower reinforcing elements, which has often proved to be a useful reference in practice. Preferred in particular is a pneumatic vehicle tire according to the invention wherein the first upper reinforcing element and the first lower reinforcing element and/or the second upper reinforcing element and the second lower reinforcing element have in relation to each other along the tire carcass a distance in the range of 0.1 to 50 mm, preferably in the range of 1 to 40 mm, particularly preferably in the range of 5 to 30 mm, most particularly preferably in the range of 10 to 20 mm, and/or wherein the first upper reinforcing element and the first lower reinforcing element and/or the second upper reinforcing element and the second lower reinforcing element have in relation to each other along the tire carcass a distance which is in the range of 10 to 90%, preferably 20 to 80%, particularly preferably 30 to 70%, most particularly preferably 40 to 60%, of the width of the respective lower reinforcing element.

However, a particularly advantageous configuration with regard to the optimum sidewall robustness is obtained if an upper reinforcing element and the associated lower reinforcing element are arranged on different sides of the tire carcass, but in each case extend so far along the tire carcass in the side areas that there is in effect an overlap and the distance between the upper and the lower reinforcing element in a subsection of the tire carcass is only ensured by the tire carcass itself. This overlap surprisingly does not adversely affect the noise generation excessively, but creates a particularly thick multi-ply assembly in the corresponding subsection, so that a particularly high mechanical stability can be achieved locally. Preferred therefore is a pneumatic vehicle tire according to the invention wherein the first upper reinforcing element and the first lower reinforcing element and/or the second upper reinforcing element and the second lower reinforcing element are arranged on different sides of the tire carcass and both are in contact with the same subsection of the tire carcass.

Analogously to the advantageous arrangement of the lower reinforcing elements identified above, the inventors have also succeeded in providing favorable positionings for the upper reinforcing elements, it tending to be more advantageous according to the inventors' assessment if the upper reinforcing elements do not extend too far into the sidewall areas. To be specific, preferred is a pneumatic vehicle tire according to the invention wherein the first upper reinforcing element and/or the second upper reinforcing element is/are arranged 10 to 70%, preferably 20 to 60%, particularly preferably 30 to 50%, in the respective sidewall area, based on the respective width of the reinforcing element, and/or wherein the first upper reinforcing element and/or the second upper reinforcing element is/are arranged 30 to 90%, preferably 40 to 80%, particularly preferably 50 to 70%, in the central area, based on the respective width of the reinforcing element.

### BRIEF DESCRIPTION OF DRAWINGS

Preferred embodiments of the invention are subsequently explained and described in more detail with reference to the accompanying figures, in which:

FIG. 1 shows a highly schematic representation of a pneumatic vehicle tire according to the prior art given by way of example, with the visualization of the various areas of the tire carcass;

FIG. 2 shows a first set of schematic representations of a sidewall of a pneumatic vehicle tire according to the invention in various preferred embodiments;

FIG. 3 shows a second set of schematic representations of a sidewall of a pneumatic vehicle tire according to the invention in various preferred embodiments;

FIG. 4 shows a third set of schematic representations of a sidewall of a pneumatic vehicle tire according to the invention in various preferred embodiments;

FIG. 5 shows a highly schematic representation of a pneumatic vehicle tire according to the invention in a first preferred embodiment;

FIG. 6 shows a highly schematic representation of a pneumatic vehicle tire according to the invention in a second preferred embodiment;

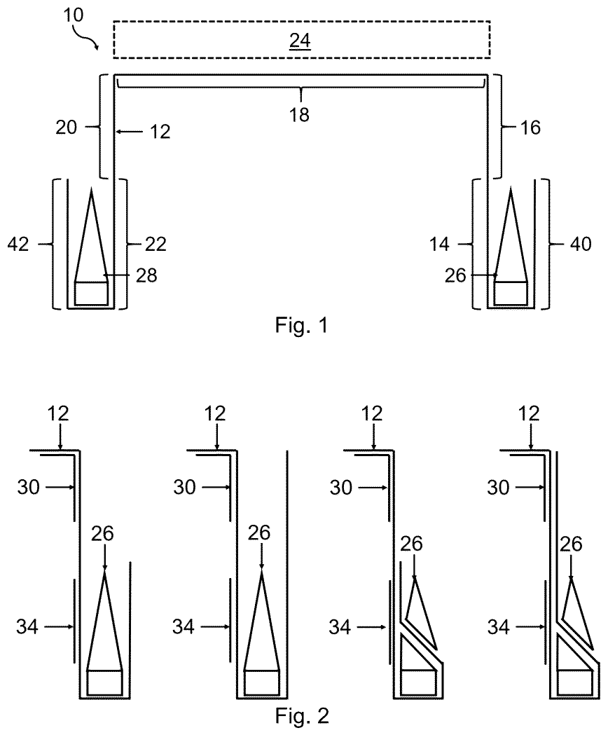

FIG. 1 shows an abstract representation of a pneumatic vehicle tire 10, as it is known from the prior art and is used in particular for the visualization of the various areas of the tire carcass 12. In addition to the tire carcass 12, the pneumatic vehicle tire 10 comprises a tread 24 with the radially underlying breaker belt package, which is preferably covered by a circular bandage (not shown). Extending under the tread 24 is the central area 18, which is framed by the first sidewall area 16 and the second sidewall area 20, which extend on the side of the pneumatic vehicle tire and which respectively form the tire shoulders at the transition to the central area 18. These sidewall areas are adjoined on both sides by the first bead area 14 and the second bead area 22, on which the first flipper strip 26 and the second flipper strip 28 are arranged. The tire carcass 12 is turned up around the respective flipper strips and forms on the sides of the tire carcass 12 the first turn-up area 40 and the second turn-up area 42 (while the offset between the bead areas and the turn-up areas below the flipper strip is due to the form of representation and does not occur in practice or has a negligible width).

FIG. 2 schematically shows a first set of constructions given by way of example of the sidewalls of a pneumatic vehicle tire 10 according to the invention, wherein only one side of the tire carcass 12 is shown in each case. In FIG. 2, the first upper reinforcing element 30 and the first lower reinforcing element 34 are placed at the same location in all four embodiments shown, though the first turn-up area 40 and the first flipper strip 26 are formed differently. The first and third representations of FIG. 2 have a shorter first turn-up area 40 compared to the second and fourth representations. The third and fourth representations of FIG. 2 show a multi-part first flipper strip 26, so that a part of the first flipper strip 26 is completely encased by the tire carcass 12, whereas the second part of the first flipper strip 26 nestles against the turned-up tire carcass 12 on the outer side as a so-called “outer apex”.

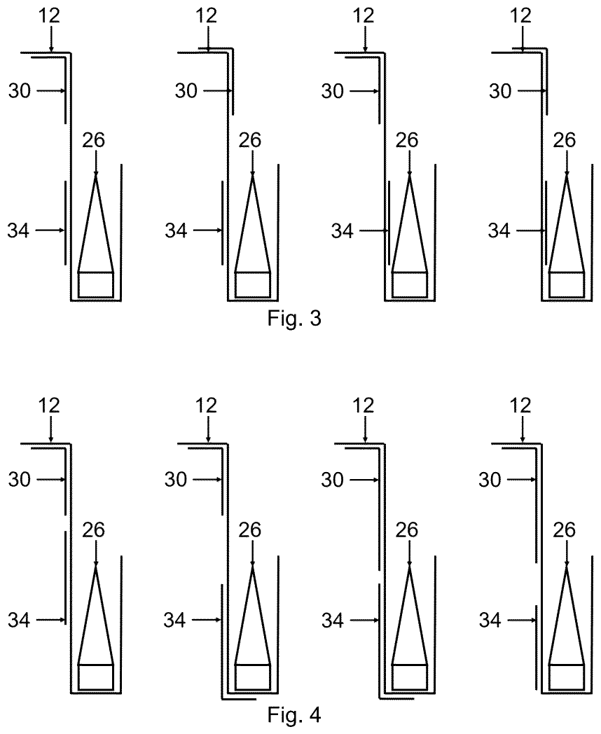

FIG. 3 schematically shows a second set of constructions given by way of example of the sidewalls of a pneumatic vehicle tire 10 according to the invention. In the embodiments shown, the positioning of the reinforcing elements varies, wherein the four possible permutations of the arrangement relative to the carcass are shown. FIG. 4 schematically shows a second set of constructions given by way of example of the sidewalls of a pneumatic vehicle tire 10 according to the invention, wherein the position and width of the reinforcing elements is varied in each case.

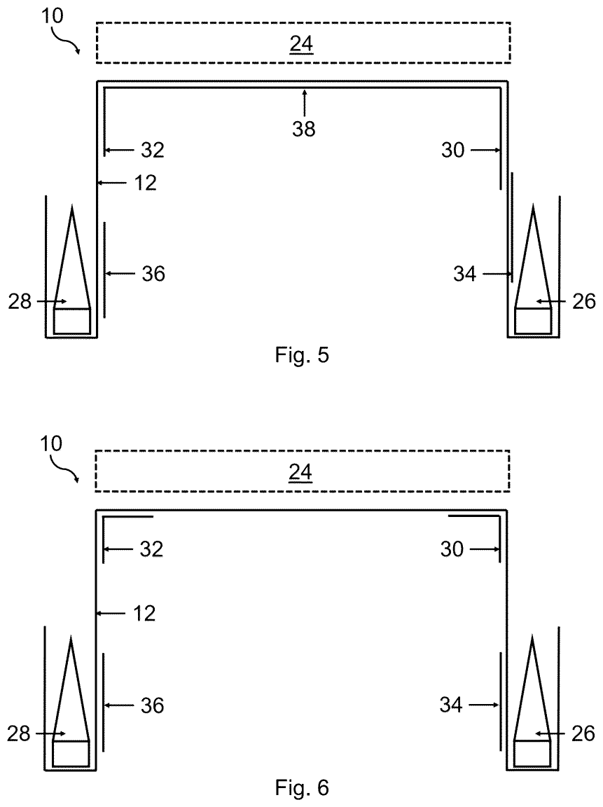

FIG. 5 shows an abstract representation of a pneumatic vehicle tire 10 according to the invention in a preferred embodiment. Compared to the representation in FIG. 1, the pneumatic vehicle tire 10 comprises a first upper reinforcing element 30 and a second upper reinforcing element 32, which in the embodiment shown are formed by a common reinforcing ply 38, which extends under the tire carcass 12. In a design given by way of example of the outer wall, the first lower reinforcing element 34 is arranged on the outer side of the tire carcass 12 in the first bead area 14 and extends into the first sidewall area 16, so that in a subsection of the first sidewall area 16 there is an overlap with the first upper reinforcing element 30 and locally a three-ply assembly is obtained, comprising the first upper reinforcing element 30, the tire carcass 12 and the first lower reinforcing element 34. In an alternative configuration, on the left side of the pneumatic vehicle tire 10 the second lower reinforcing element 36 in FIG. 5 is arranged completely in the second bead area 22 and correspondingly does not protrude beyond the end of the second flipper strip 28.

FIG. 6 finally shows an abstract representation of a pneumatic vehicle tire 10 according to the invention in a preferred embodiment, which is particularly advantageous according to the inventors' assessment. On the tire carcass 12, a first flipper strip 26 and a second flipper strip 28 are arranged in the two bead areas. The pneumatic vehicle tire 10 comprises a tread 24, with the corresponding breaker belt and/or bandage package, under which the central area 18 of the tire carcass 12 extends. The pneumatic vehicle tire 10 comprises a first upper reinforcing element 30 and a second upper reinforcing element 32, which extend from the central area 18 into the first sidewall area 16 and the second sidewall area 20 respectively. At a distance from the upper reinforcing elements, the pneumatic vehicle tire 10 comprises a first lower reinforcing element 34 and a second lower reinforcing element 36, which are in each case arranged completely in the respective bead area. The pneumatic vehicle tire 10 given by way of example is a car tire, which comprises a tread 24 of a rubber material, which has a profile on the outer side facing away from the tire carcass 12 such as is suitable for example for winter tires.

It can be clearly seen that all of the reinforcing elements are arranged on the inner side of the tire carcass 12 and that the upper reinforcing elements are formed as separate reinforcing elements that are spaced apart from one another. The pneumatic vehicle tire 10 shown has an inner tire layer (not shown), under which the reinforcing elements are arranged in such a way that they are arranged between the inner tire layer and the tire carcass 12. In the exemplary embodiment of FIG. 6, the pneumatic vehicle tire 10 does not include any additional breaker plies, so that the tread 24 is arranged directly on the radially outer-lying side of the tire carcass 12. The first flipper strip 26 and the second flipper strip 28 in each case comprise the same rubber material, which has a higher modulus of elasticity than the rubber material which is processed in the tire carcass 12 or the reinforcing elements. In addition, both flipper strips in each case comprise a bead core, which is arranged in the lower end of the respective flipper strip and is indicated by the rectangle.

The tire carcass 12 in the pneumatic vehicle tire 10 according to the invention comprises exactly one continuous carcass ply, which extends through all of the areas of the tire carcass 12. This carcass ply comprises a large number of strength members embedded in a carcass rubber material. In the exemplary embodiment of FIG. 6, the carcass strength members are metallic strength members, specifically reinforcing cords made of steel. The reinforcing elements have in the example shown a thickness of 1.1 mm and in each case comprise the same rubber material, the modulus of elasticity of which lies above that of the rubber material which is processed in the tire carcass 12.

In FIG. 7, all of the reinforcing elements also comprise strength members, which in the example shown are formed as textile strength members made of aramid and which have in each case a cord angle relative to the circumferential direction that differs from the cord angle of the carcass strength members in the tire carcass 12. In the example shown, all of the reinforcing elements have the same width, which in the embodiment shown is about 50 mm. The not-to-scale representation shows too great a distance between the reinforcing elements, since, in a pneumatic vehicle tire 10 given by way of example and considered to be particularly advantageous, it should be about 15 mm. However, it is shown to scale that the upper reinforcing elements are in each case arranged more than 50% in the central area.

### LIST OF REFERENCE SIGNS

10 Pneumatic vehicle tire
12 Tire carcass
14 First bead area
16 First sidewall area
18 Central area
20 Second sidewall area
22 Second bead area
24 Tread
26 First flipper strip
28 Second flipper strip
30 First upper reinforcing element
32 Second upper reinforcing element
34 First lower reinforcing element
36 Second lower reinforcing element
38 Reinforcing ply
40 First turn-up area
42 Second turn-up area

1-11. (canceled)

12. A pneumatic vehicle tire, comprising:
a tire carcass with a first bead area, a first sidewall area, a central area, a second sidewall area and a second bead area;
a tread, lying on the outside in the radial direction relative to the tire carcass and arranged over the central area;
a first flipper strip, arranged at the first bead area, and a second flipper strip, arranged at the second bead area;
a first upper reinforcing element, arranged at the central area and at the first sidewall area, and a second upper reinforcing element, arranged at the central area and at the second sidewall area;
a first lower reinforcing element, arranged at the first bead area, and a second lower reinforcing element, arranged at the second bead area;
the first upper reinforcing element and the second upper reinforcing element being located at a distance from the first lower reinforcing element and the second lower reinforcing element;
a first turn-up area, connected to the first bead area, and a second turn-up area, connected to the second bead area, wherein the first turn-up area and the second turn-up area lie on the outside relative to the respective bead area; and
the first flipper strip and the second flipper strip is a two-part design, the first flipper strip is arranged partially between the first bead area and the first turn-up area and partially on the outer side of the first turn-up area and the second flipper strip is arranged partially between the second bead area and the second turn-up area and partially on the outer side of the second turn-up area.

13. The pneumatic vehicle tire as claimed in claim 12, wherein the first upper reinforcing element and the second upper reinforcing element are located at a distance from one another, or wherein the first upper reinforcing element and the second upper reinforcing element are formed by a reinforcing ply, wherein the reinforcing ply preferably extends over the entire central area into the sidewall areas.

14. The pneumatic vehicle tire as claimed in claim 12, wherein the first upper reinforcing element and the second upper reinforcing element are arranged on the inner side of the tire carcass and the first lower reinforcing element and the second lower reinforcing element are arranged on the inner side of the tire carcass.

15. The pneumatic vehicle tire as claimed in claim 12 wherein the tire carcass comprises one carcass ply that extend as a continuous carcass ply through all of the areas of the tire carcass.

16. The pneumatic vehicle tire as claimed in claim 12, wherein the carcass ply has a plurality of carcass strength members that are embedded in a carcass rubber material.

17. The pneumatic vehicle tire as claimed in claim 12, wherein the first flipper strip comprises a flipper-strip rubber material, wherein the flipper-strip rubber material has a higher modulus of elasticity than the carcass rubber material, wherein the flipper-strip rubber material preferably has a higher modulus of elasticity than the rubber materials of the reinforcing elements.

18. The pneumatic vehicle tire as claimed in claim 12, wherein the first upper reinforcing element comprises a first rubber material, and wherein the second upper reinforcing element comprises a second rubber material, and wherein the first lower reinforcing element comprises a third rubber material, and wherein the second lower reinforcing element comprises a fourth rubber material, wherein the first rubber material and the second rubber material and the third rubber material and the fourth rubber material, preferably all of the rubber materials, has/have a higher modulus of elasticity than the carcass rubber material.

19. The pneumatic vehicle tire of claim 12, wherein the first upper reinforcing element comprises a plurality of first strength members, and wherein the second upper reinforcing element comprises a plurality of second strength members, and the first lower reinforcing element comprises a plurality of third strength members, and the second lower reinforcing element comprises a plurality of fourth strength members, the first strength members and the second strength members and the third strength members and the fourth strength members are different from the carcass strength members with regard to the material and the fineness.

20. The pneumatic vehicle tire as claimed in claim 12, wherein the strength members in the first upper reinforcing element and in the first lower reinforcing element and in the second upper reinforcing element and in the second lower reinforcing element, preferably the strength members in the strength members in the first lower reinforcing element and in the second lower reinforcing element, have a cord angle relative to the circumferential direction that differs from the cord angle of the carcass strength members in the tire carcass.
